(19) United States
(12) Patent Application Publication
(10) Pub. No.: US 2021/0396197 A1
(43) Pub. Date: Dec. 23, 2021

(54) PUMP ACTUATOR WITH INCREASED BODY STRENGTH

(71) Applicant: Eaton Intelligent Power Limited, Dublin (IE)

(72) Inventors: Kapil Mohadikar, Pune (IN); Chetankumar Shirsat, Rahatani (IN)

(73) Assignee: Eaton Intelligent Power Limited, Dublin (IE)

(21) Appl. No.: 17/462,653

(22) Filed: Aug. 31, 2021

Related U.S. Application Data
(63) Continuation of application No. PCT/EP2020/025106, filed on Mar. 2, 2020.

(30) Foreign Application Priority Data
Mar. 2, 2019 (IN) 201911008252

(51) Int. Cl. F02M 59/02; F02M 59/10; F04B 53/16

(52) U.S. Cl. CPC F02M 59/027; F04B 53/16; F02M 59/102

(57) ABSTRACT

A pump actuator for use between a cam and a pump is disclosed. The pump actuator comprises a pump actuator body having a structural enhancing feature. The pump actuator body comprises a pad defined between a plunger facing surface and an opposite roller facing surface. The plunger facing surface is recessed into the pump actuator body and offset from a radial end. The pump actuator body further includes a cylindrical wall defined between the radial end and the plunger facing surface. The structural enhancing feature is formed on the pad on the plunger facing surface. The structural enhancing feature increases load carrying capacity of the pump actuator body.

### CROSS-REFERENCE TO RELATED APPLICATIONS

This application is a continuation of International Application No. PCT/EP2020/025106 filed Mar. 2, 2020, which claims the benefit of Indian Provisional Patent Application No. 201911008252, filed on Mar. 2, 2019. The disclosure of the above application is incorporated herein by reference.

### FIELD

The present disclosure relates generally to a pump actuator or roller tappet and more particularly to a pump actuator having improved load carrying capacity and body strength.

### BACKGROUND

A pump actuator is an integral component of a spark ignition direct injection (SIDI) fuel system. The pump actuator redirects fuel pump cam rotary motion into linear fuel pump drive motion. The pump actuator is a roller follower that is sandwiched between a cam and a gasoline direct injection (GDI) pump. During operation the pump actuator will pressurize fuel inside the GDI pump so as to maintain pressure inside the fuel rail. Typical direct injection fuel pressure can be 90 times higher than conventional fuel pressures. It is desirable to increase load carrying capacity and reduce friction of the pump actuator. Furthermore, it is desirable to reduce cost with alternate geometry, materials and manufacturing processes.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A pump actuator for use between a cam and a pump is provided. The pump actuator comprises a pump actuator body having a structural enhancing feature. The pump actuator body comprises a pad defined between a plunger facing surface and an opposite roller facing surface. The plunger facing surface is recessed into the pump actuator body and offset from a radial end. The pump actuator body further includes a cylindrical wall defined between the radial end and the plunger facing surface. The structural enhancing feature is formed on the pad on the plunger facing surface. The structural enhancing feature increases load carrying capacity of the pump actuator body.

According to additional features, the structural enhancing feature comprises a rib. The pump actuator body is unitary. The rib extends the entire distance across the plunger facing surface and terminates at opposing areas of the cylindrical wall. A thickness of the pad at the rib is about a third thicker than a thickness of the pad absent the rib. A thickness of the rib increases a thickness of the pad by one third. The rib thickness is about 0.7 mm. The thickness of the pad and rib collectively is about 3 mm.

According to other features, the structural enhancing feature further comprises a dimple. The dimple can be formed into the rib. The dimple can be centrally formed relative to the cylindrical wall. A thickness of the pad at the rib is about a third thicker than a thickness of the pad at the dimple.

According to still other features, the structural enhancing feature comprise a dimple. A thickness of the pad is about a third thicker than a thickness of the pad at the dimple.

A pump actuator for use between a cam and a pump according to additional features includes a pump actuator body and an axle. The pump actuator body has a pad defined between a plunger facing surface and an opposite roller facing surface. The plunger facing surface is recessed into the pump actuator body and offset from a radial end. The pump actuator body further includes a cylindrical wall defined between the radial end and the plunger facing surface. The axle is supported in the axle openings defined in the pump actuator body. The axle extends along a longitudinal direction. A rib is formed on the pad on the plunger facing surface. The rib extends in a parallel direction relative to the longitudinal direction. The rib increases load carrying capacity of the pump actuator body.

In other features, the pump actuator body is unitary. The rib can extend the entire distance across the plunger facing surface and terminates at opposing areas of the cylindrical wall. A thickness of the pad at the rib is about a third thicker than a thickness of the pad absent the rib. A thickness of the rib increases a thickness of the pad by one third. The rib thickness is about 0.7 mm. The thickness of the pad and rib collectively is about 0.3 mm.

A pump actuator for use between a cam and a pump according to additional features includes a unitary pump actuator body and an axle. The pump actuator body has a pad defined between a plunger facing surface and an opposite roller facing surface. The plunger facing surface is recessed into the pump actuator body and offset from a radial end. The pump actuator body further includes a cylindrical wall defined between the radial end and the plunger facing surface. The axle is supported in the axle openings defined in the pump actuator body. The axle extends along a longitudinal direction. A rib is formed on the pad on the plunger facing surface. The rib extends in a parallel direction relative to the longitudinal direction. The rib increases load carrying capacity of the pump actuator body. A dimple can be formed on the pad at the rib.

### BRIEF DESCRIPTION OF THE DRAWINGS

The present disclosure will become more fully understood from the detailed description and the accompanying drawings, wherein:

FIG. 1 is a front perspective view of a pump actuator arranged between a cam on a camshaft and a high pressure GDI pump according to one example of prior art

FIG. 2A is an exploded view of a pump actuator according to prior art;

FIG. 2B is an exemplary manufacturing process according to one example of the present disclosure;

FIG. 3A is a top perspective view of a pump actuator body according to one prior art example;

FIG. 3B is a sectional view taken through the pump actuator body of FIG. 3A taken along lines 3B-3B;

FIG. 3C is a stress analysis showing a max stress of 543 MPa experienced by the pump actuator body of FIG. 3A;

FIG. 4A is a top perspective view of a pump actuator body constructed in accordance to one example of the present disclosure;

FIG. 4B is a sectional view taken through the pump actuator body of FIG. 4A taken along lines 4B-4B;

FIG. 4C is a stress analysis showing a max stress of 381 MPa experienced by the pump actuator body of FIG. 4A;

FIG. 5A is a top perspective view of a pump actuator body constructed in accordance to another example of the present disclosure;

FIG. 5B is a sectional view taken through the pump actuator body of FIG. 5A taken along lines 5B-5B;

FIG. 5C is a stress analysis showing a max stress of 488 MPa experienced by the pump actuator body of FIG. 5A;

FIG. 6A is a top perspective view of a pump actuator body constructed in accordance to yet another example of the present disclosure;

FIG. 6B is a sectional view taken through the pump actuator body of FIG. 6A taken along lines 6B-6B; and

FIG. 6C is a stress analysis showing a max stress of 440 MPa experienced by the pump actuator body of FIG. 6A.

### DETAILED DESCRIPTION

A GDI Pump is used to supply pressurized fuel either in an intake manifold or in a common rail of fuel injectors of an engine. A GDI pump can be operated using a cam shaft lobe. For a GDI pump, roller tappets can be used to reduce friction between the plunger and the cam shaft lobe. Roller tappets need to sustain high pressure forces of the pump. With increasing pressure requirements, pressure forces increase and it is necessary that the roller tapped sustain these forces. The present teachings incorporate the addition of ribs on the plunger side of the tappet to increase strength in a cost effective manner.

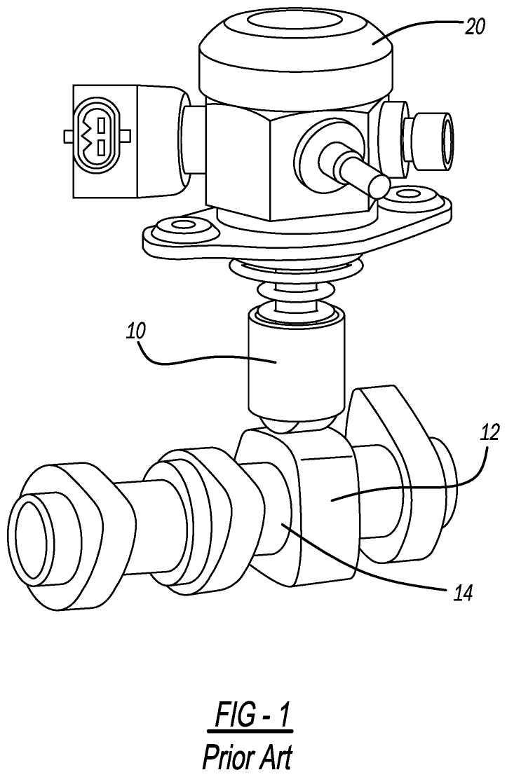

With initial reference to FIG. 1, a pump actuator or roller tappet constructed in accordance to one prior art example is shown and generally identified at reference numeral 10. The pump actuator 10 is shown in operative engagement with a cam 12 on a camshaft 14. Translation of the pump actuator 10 pressurizes fuel inside a GDI pump 20. The pump actuator 10 uses rotatable motion of the camshaft 14 and converts the rotatable motion into linear fuel pump drive motion. Typical DI fuel pressure (350 bar) can be about 90 times higher than conventional PI fuel pressures.

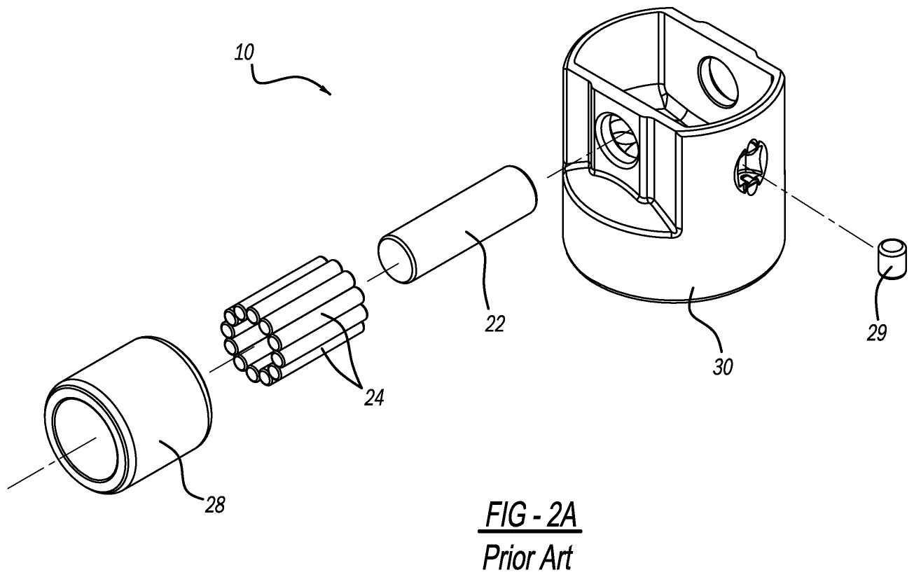

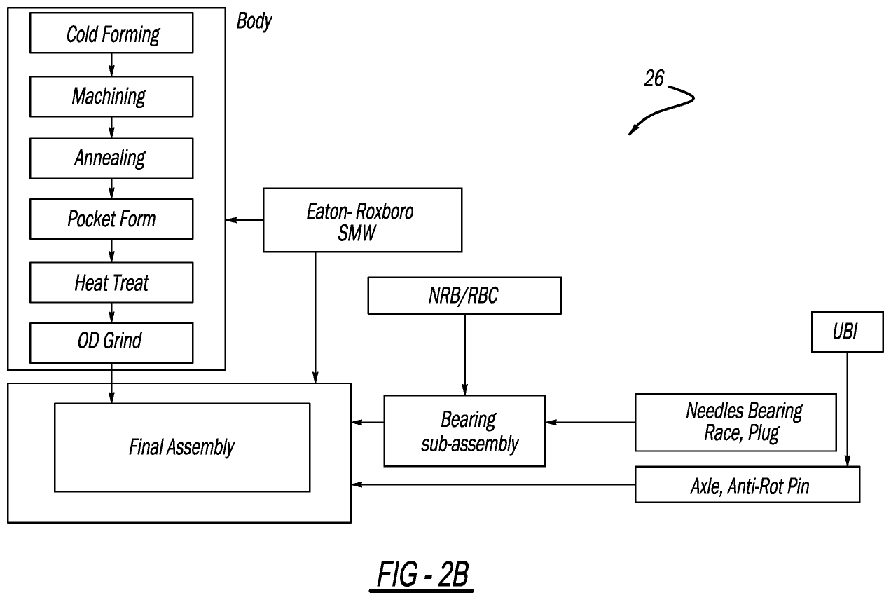

An exploded view of the exemplary pump actuator 10 shown in FIG. 1 is illustrated in FIG. 2A. The pump actuator 10 generally comprises an axle 22, a plurality of needles 24, a roller 28, an anti-rotation pin 29 and a pump actuator body 30. An exemplary manufacturing process for manufacturing the pump actuator 10 is shown generally at reference 26 in FIG. 2B.

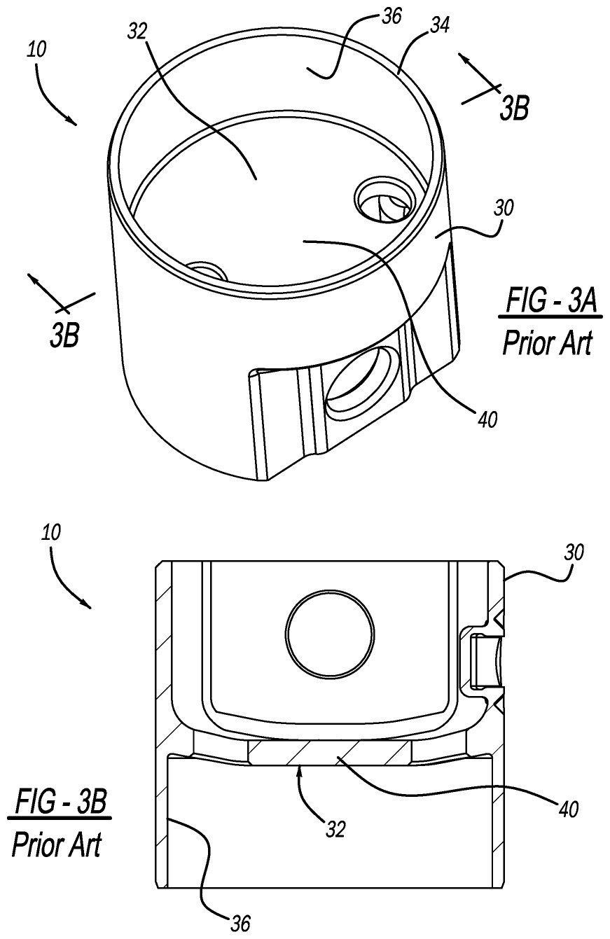

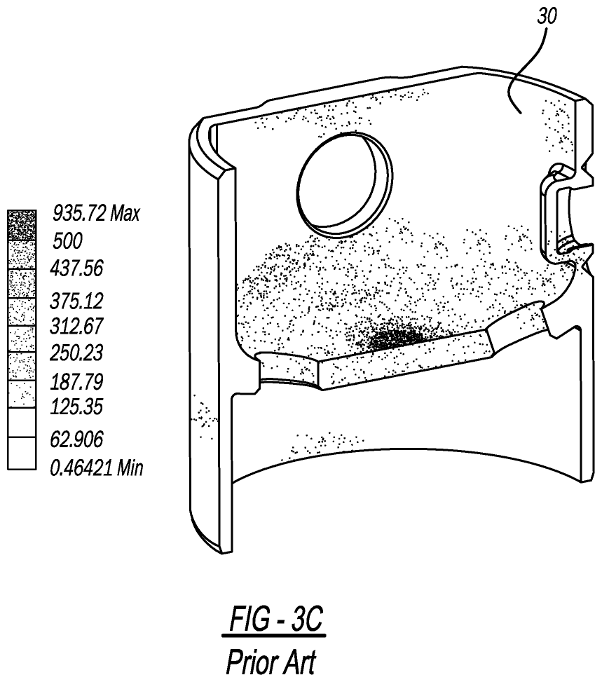

The prior art pump actuator 10 is shown in FIGS. 3A-3C. The pump actuator body 30 of the prior art pump actuator 10 has a load carrying capacity of 20 MPa. The pump actuator body 30 generally defines a plunger facing surface 32 that is generally recessed into the pump actuator body 30 and offset from a radial end 34. A cylindrical wall 36 is generally defined between the radial end 34 and the plunger facing surface 32. The plunger facing surface 32 is generally planar and together with an opposite roller facing surface 38 defines a pad 40. The pad 40 can be around 2.3 mm thick according to the prior art example shown. FIG. 3C is a stress analysis showing a max stress of 543 MPa experienced by the pump actuator body

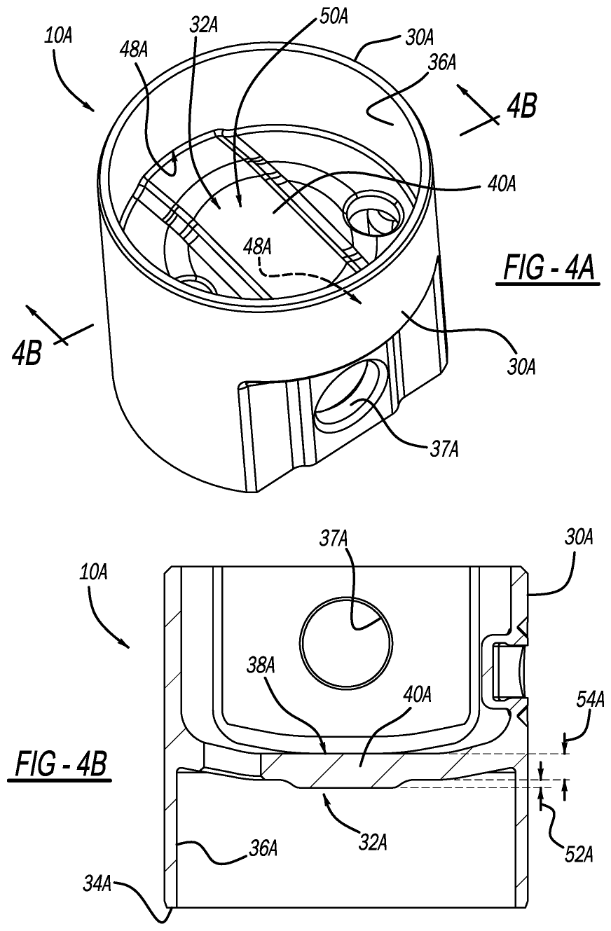

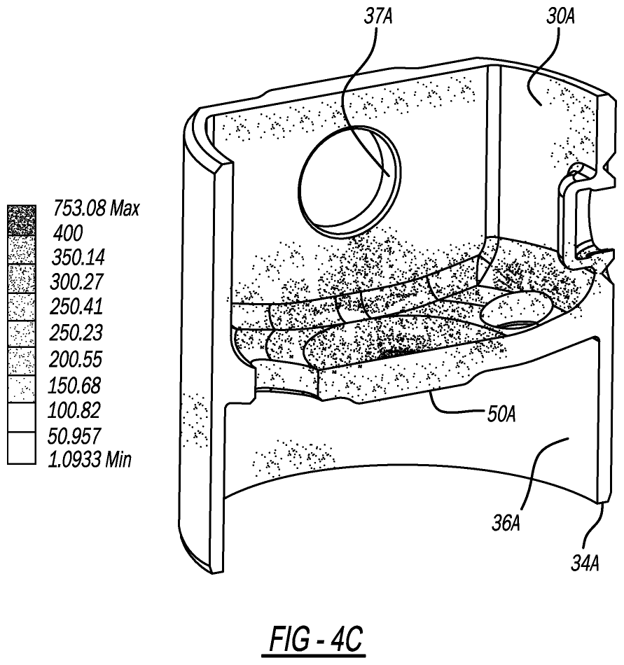

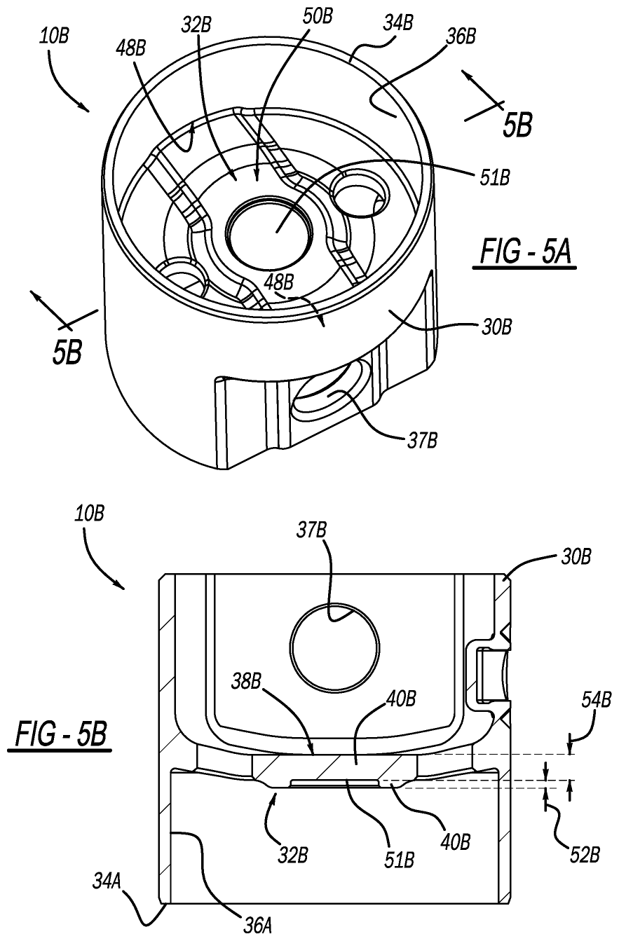

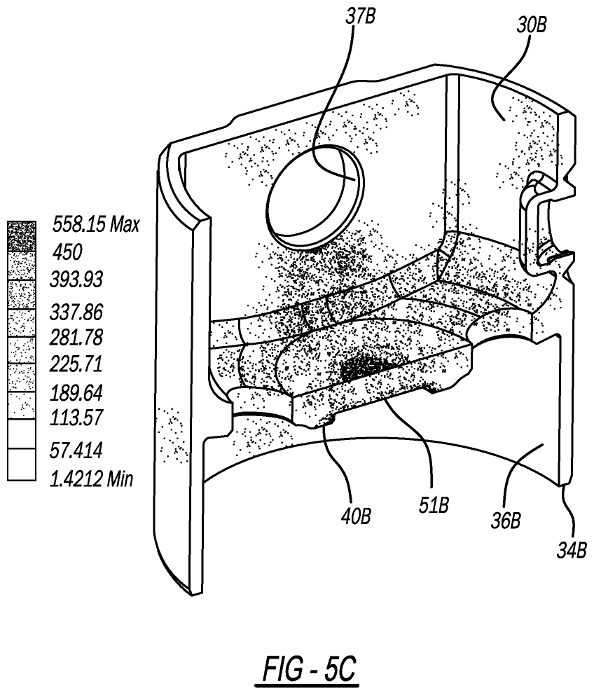

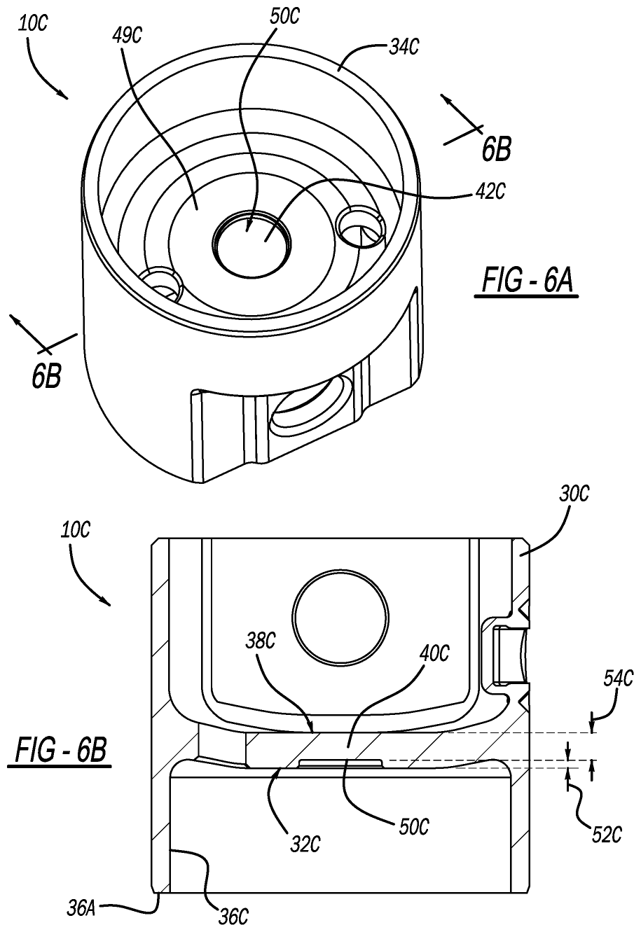

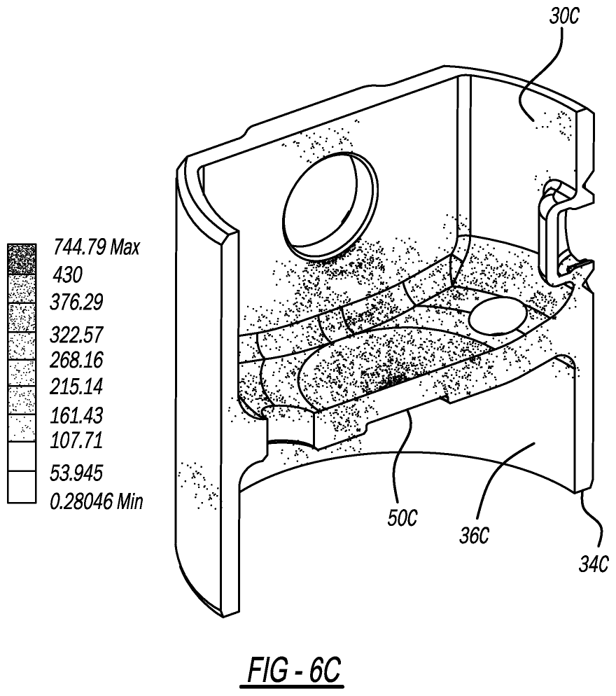

As will become appreciated from the following discussion, the instant application provides pump actuators that have increased load carrying capacity (from 20 MPa to of 35 MPa). The examples according to the present disclosure each comprise a pad that incorporates a structural enhancing feature thereon. As will be explained herein, the structural enhancing feature can include a rib 50A (FIGS. 4A-4C), a rib and dimple combination 50B (FIGS. 5A-5C) and a dimple 50C (FIGS. 6A-6C).

A pump actuator 10A constructed in accordance to one example of the present disclosure is shown in FIGS. 4A-4C. The pump actuator 10A includes a pump actuator body 30A that generally defines a plunger facing surface 32A that is generally recessed into the pump actuator body 30A and offset from a radial end 34A. A cylindrical wall 36A is generally defined between the radial end 34A and the plunger facing surface 32A. The pump actuator body 30A defines axle openings 37A configured to support an axle (see axle 22, FIG. 2A). The plunger facing surface 32A and an opposite roller facing surface 38A defines a pad 40A. The pad 40A incorporates a structural enhancing feature in the form of a rib 50A. The rib 50A extends the entire distance across the plunger facing surface 32A and terminates at opposing areas 48A of the cylindrical wall 36A. The rib 50A generally extends parallel to a direction of the axle (see axle 22, FIG. 2A). The rib 50A provides enhanced stiffness and strength to the pump actuator body 30A. In one configuration, the rib 50A can have a thickness 52A. The thickness 52A can be about 0.7 mm. The pad 40A can have a thickness 54A. The thickness 54A can be 2.3 mm. The pad 40A together with the 0.7 mm rib 50A can have an increased load carrying capacity and withstand a max stress of 381 MPa. The rib 50A helps increase the strength of the pad 40A. The pump actuator body 30A can be a one-piece body made of a forging or casting. The pump actuator body 30A made from a unitary piece of metal is stronger than prior art examples that may be formed of multiple stampings.

A pump actuator 10B constructed in accordance to one example of the present disclosure is shown in FIGS. 5A-5C. The pump actuator 10B includes a pump actuator body 30B that generally defines a plunger facing surface 32B that is generally recessed into the pump actuator body 30B and offset from a radial end 34B. A cylindrical wall 36B is generally defined between the radial end 34B and the plunger facing surface 32B. The pump actuator body 30A defines axle openings 37B configured to support an axle (see axle 22, FIG. 2A). The plunger facing surface 32B and an opposite roller facing surface 38B defines a pad 40B. The pad 40B incorporates a structural enhancing feature in the form of a rib 50B and dimple 51B. The rib 50B extends the entire distance across the plunger facing surface 32B and terminates at opposing areas 48B of the cylindrical wall 36B. The rib 50B generally extends parallel to a direction of the axle (see axle 22, FIG. 2A). The rib 50B provides enhanced stiffness and strength to the pump actuator body 30B. In one configuration, the rib 50B can have a thickness 52B. The thickness 52B can be about 0.7 mm. The dimple 51B can be recessed into the rib 50B toward the pad 40B. In some examples the dimple can be recessed the distance 52B. The pad 40B can have a thickness 54B. The thickness 54B can be 2.3 mm. The pad 40B together with the 0.7 mm rib 50B can have an increased load carrying capacity and withstand a max stress of 488 MPa. The rib 50B helps increase the strength of the pad 40B. The pump actuator body 30B can be a one-piece body made of a forging or casting. The pump actuator body 30B made from a unitary piece of metal is stronger than prior art examples that may be formed of multiple stampings.

A pump actuator 10C constructed in accordance to one example of the present disclosure is shown in FIGS. 6A-6C. The pump actuator 10C includes a pump actuator body 30C that generally defines a plunger facing surface 32C that is generally recessed into the pump actuator body 30C and offset from a radial end 34C. A cylindrical wall 36C is generally defined between the radial end 34C and the plunger facing surface 32C. The plunger facing surface 32C and an opposite roller facing surface 38C defines a pad 40C. The pad 40C incorporates a structural enhancing feature in the form of a raised central body portion 49C having a dimple 50C. The dimple 50C provides enhanced stiffness and strength to the pump actuator body 30C. In one configuration, the dimple 50C can have a depth 52B into the raised central body portion 49C. The depth 52B can be about 0.7 mm. The dimple 50C can be recessed toward the pad 40C. The pad 40C can have a thickness 54B. The thickness 54B can be 2.3 mm. The pad 40C together with the 0.7 mm raised central body portion 49C can have an increased load carrying capacity and withstand a max stress of 440 MPa. The raised central body portion 49C and dimple 50C helps increase the strength of the pad 40C. The pump actuator body 30C can be a one-piece body made of a forging or casting. The pump actuator body 30C made from a unitary piece of metal is stronger than prior art examples that may be formed of multiple stampings.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A pump actuator for use between a cam and a pump, the pump actuator comprising:
a pump actuator body having a pad defined between a plunger facing surface and an opposite roller facing surface, the plunger facing surface being recessed into the pump actuator body and offset from a radial end, the pump actuator body further including a cylindrical wall defined between the radial end and the plunger facing surface; and
a structural enhancing feature formed on the pad on the plunger facing surface, the structural enhancing feature increasing load carrying capacity of the pump actuator body.

2. The pump actuator of claim 1 wherein the structural enhancing feature comprises a rib.

3. The pump actuator of claim 2 wherein the pump actuator body is unitary.

4. The pump actuator of claim 3 wherein the rib extends the entire distance across the plunger facing surface and terminates at opposing areas of the cylindrical wall.

5. The pump actuator of claim 4 wherein a thickness of the pad at the rib is about a third thicker than a thickness of the pad absent the rib.

6. The pump actuator of claim 4 wherein a thickness of the rib increases a thickness of the pad by one third.

7. The pump actuator of claim 6 wherein the rib thickness is about 0.7 mm and wherein the thickness of the pad and rib collectively is about 3 mm.

8. The pump actuator of claim 2 wherein the structural enhancing feature further comprises a dimple.

9. The pump actuator of claim 8 wherein the dimple is formed into the rib.

10. The pump actuator of claim 9 wherein the dimple is centrally formed relative to the cylindrical wall.

11. The pump actuator of claim 10 wherein a thickness of the pad at the rib is about a third thicker than a thickness of the pad at the dimple.

12. The pump actuator of claim 1 wherein the structural enhancing feature comprises a dimple.

13. The pump actuator of claim 12 wherein a thickness of the pad is about a third thicker than a thickness of the pad at the dimple.

14. A pump actuator for use between a cam and a pump, the pump actuator comprising:
a pump actuator body having a pad defined between a plunger facing surface and an opposite roller facing surface, the plunger facing surface being recessed into the pump actuator body and offset from a radial end, the pump actuator body further including a cylindrical wall defined between the radial end and the plunger facing surface;
an axle supported in axle openings defined in the pump actuator body, the axle extending along a longitudinal direction; and
a rib formed on the pad on the plunger facing surface, the rib extending in a parallel direction relative to the longitudinal direction, the rib increasing load carrying capacity of the pump actuator body.

15. The pump actuator of claim 14 wherein the pump actuator body is unitary.

16. The pump actuator of claim 15 wherein the rib extends the entire distance across the plunger facing surface and terminates at opposing areas of the cylindrical wall.

17. The pump actuator of claim 16 wherein a thickness of the pad at the rib is about a third thicker than a thickness of the pad absent the rib.

18. The pump actuator of claim 16 wherein a thickness of the rib increases a thickness of the pad by one third.

19. The pump actuator of claim 18 wherein the rib thickness is about 0.7 mm and wherein the thickness of the pad and rib collectively is about 3 mm.

20. A pump actuator for use between a cam and a pump, the pump actuator comprising:
a unitary pump actuator body having a pad defined between a plunger facing surface and an opposite roller facing surface, the plunger facing surface being recessed into the pump actuator body and offset from a radial end, the pump actuator body further including a cylindrical wall defined between the radial end and the plunger facing surface;
an axle supported in axle openings defined in the pump actuator body, the axle extending along a longitudinal direction;
a rib formed on the pad on the plunger facing surface, the rib extending in a parallel direction relative to the longitudinal direction, the rib increasing load carrying capacity of the pump actuator body; and
a dimple formed on the pad at the rib.
